(19) United States
(12) Patent Application Publication
(10) Pub. No.: US 2006/0241945 A1
(43) Pub. Date: Oct. 26, 2006

(54) Control of settings using a command rotor

(76) Inventor: Anthony E. Morales, Mountain View, CA (US)

Correspondence Address: FISH & RICHARDSON P.C., PO BOX 1022, MINNEAPOLIS, MN, 55440-1022, US

(21) Appl. No.: 11/114,990

(22) Filed: Apr. 25, 2005

(51) Int. Cl. G10L 13/08

(52) U.S. Cl. 704/260

(57) ABSTRACT

Systems and methods are provided for adjusting parameter levels. A method can include providing a plurality of parameters, each parameter being adjustable over a dimension; enabling a set of keys to adjust the plurality of parameters; selecting from amongst the plurality of parameters a parameter for adjustment using a first set of one or more keys from the set of keys; and adjusting a dimension of a selected parameter using a second set of one or more keys from the set of keys.

### BACKGROUND

The following disclosure generally relates to computing systems.

One type of software application used by an individual with a disability is an accessibility application. Accessibility applications can provide a set of tools to assist disabled users. The set of tools can include a screen reader that reads text being displayed on the screen using a text-to-speech application.

Software applications and system hardware of a computer typically include settings that affect their operation. For example, a conventional text-to-speech application for vision-impaired users typically has settings related to verbosity and voice. Verbosity levels can typically be adjusted to control how user interactions are translated to speech. Voice levels can typically be adjusted to control rate, pitch or volume of a voice used to produce speech.

One primary technique of adjusting settings and interacting with a computer is through a graphical user interface of a computer. To do so, a user can navigate a graphical user interface to find an appropriate drop-down box or icon for selection. The selection can spawn a pop-up window having several tabs of settings. After finding a desired tab, a user can navigate through one or more settings within the tab. At a desired setting, a level can be adjusted (e.g., volume up or volume down). The pop-up window may then be closed using, for example, a small button located in a corner of the window. Graphical user interfaces, while useful to many people, impose a challenge to those with disabilities such as blindness, visual impairment, and motor challenges.

Some accessibility applications attempt to provide full keyboard navigation (FKN). This means that while a graphical user interface can be designed primarily for mouse manipulation, it can also be driven from a keyboard by using keyboard commands to move around a screen or to select functions of applications that are currently in focus or displayed by the operating system. However, existing accessibility applications are not able to allow a user to access some options or features of a graphical user interface. Also, the FKN may have key mappings that conflict with the key mappings of other applications. This causes a loss of functionality in the graphical user interface, stranding the user to rely on the navigation and utilities provided by the accessibility application.

### SUMMARY

This disclosure generally describes systems, methods, computer program products, and means for adjusting settings (or parameters) of a software application or system hardware. A proposed system provides robust navigation of settings to applications or system hardware (e.g., for vision-impaired users). The proposed system can adjust several settings with a few keystrokes rather than by tedious navigation through graphical user interfaces. Additionally, the proposed system can be activated/deactivated on, for example, a computer used by both vision-impaired and conventional users without burdening a conventional user that is not interested in features of the proposed system.

In general, in one aspect, a method is provided. The method includes providing a plurality of parameters, each parameter being adjustable over a dimension; enabling a set of keys to adjust the plurality of parameters; selecting from amongst the plurality of parameters a parameter for adjustment using a first set of one or more keys from the set of keys; and adjusting a dimension of a selected parameter using a second set of one or more keys from the set of keys.

Particular implementations can include one or more of the following features. The plurality of parameters can include parameters associated with a text-to-speech application. The plurality of parameters associated with the text-to-speech application can include one or more of voice rate, voice pitch, or voice volume. The plurality of parameters include parameters associated with system hardware. The dimension can include a range of levels. Each key in the set of keys can be proximately located relative to other keys. Each key in the set of keys can include virtual keys.

The method can further include disabling default functions associated with the set of keys. Enabling can include, responsive to depressing one or more activation keys, enabling the set of keys to adjust the plurality of parameters. Selecting can include scrolling through the plurality of parameters to select the parameter for adjustment. The method can further include storing a dimension level associated with each of the plurality of parameters, wherein selecting can include displaying the stored levels while scrolling through the plurality of parameters. The method can further include outputting an audio segment in accordance with the adjusted level. Adjusting can include outputting to an operating system a command in accordance with the adjusted dimension level.

In general, in another aspect, a computer program product is provided. The computer program product includes instructions tangibly stored on a computer-readable medium and includes an input capture routine to receive input from a command rotor associated with a plurality of parameters, each parameter being adjustable over a dimension, the input capture routine detecting enablement of the command rotor; and a matrix, in communication with the input capture routine and responsive to a first set of one or more keys from a set of keys associated with the command rotor, to select a parameter for adjustment and, responsive to a second set of one or more keys from the set of keys associated with the command rotor, to adjust a dimension of a selected parameter.

In general, in anther aspect, a system is included. The system includes an input capture routine to receive input from a command rotor associated with a plurality of parameters, each parameter being adjustable over a dimension, the input capture routine detecting enablement of the command rotor; and a matrix, in communication with the input capture routine and responsive to a first set of one or more keys from a set of keys associated with the command rotor, to select a parameter for adjustment and, responsive to a second set of one or more keys from the set of keys associated with the command rotor, to adjust a dimension of a selected parameter.

Particular implementations can include one or more of the following features. The plurality of parameters can include parameters associated with a text-to-speech application. The plurality of parameters associated with the text-to-speech application can include one or more of voice rate, voice pitch, or voice volume. The plurality of parameters can include parameters associated with system hardware. The dimension can include a range of levels. Each key in the set of keys can be proximately located relative to other keys. Each key in the set of keys can include virtual keys.

The input capture routine can disable default functions associated with the set of keys. The input capture routine, responsive to depressing one or more activation keys, can enable the set of keys to adjust the plurality of parameters. The matrix can scroll through the plurality of parameters to select the parameter for adjustment. The matrix can store a dimension level associated with each of the plurality of parameters and can display the stored levels while scrolling through the plurality of parameters. The system can include an audio output to output an audio segment in accordance with the adjusted level. The system can include a translator, coupled to the matrix, to output to an operating system a command in accordance with the adjusted dimension level.

### DESCRIPTION OF DRAWINGS

FIG. 1 is a block diagram illustrating a proposed system to adjust settings.

FIG. 2 is a schematic diagram illustrating a keyboard of the system of FIG. 1.

FIG. 3 is a block diagram illustrating a command rotor of the system of FIG. 1.

FIG. 4 is a table illustrating parameters and levels (or dimensions) of settings.

FIG. 5 is a flow diagram illustrating a method for adjusting settings.

FIG. 6 is a flow diagram illustrating a method of scrolling through and adjusting parameters.

### DETAILED DESCRIPTION

Systems, methods, computer program products, and means for adjusting settings of a software application or system hardware are described. Accessibility applications are described below by way of example, and are not intended to be limiting.

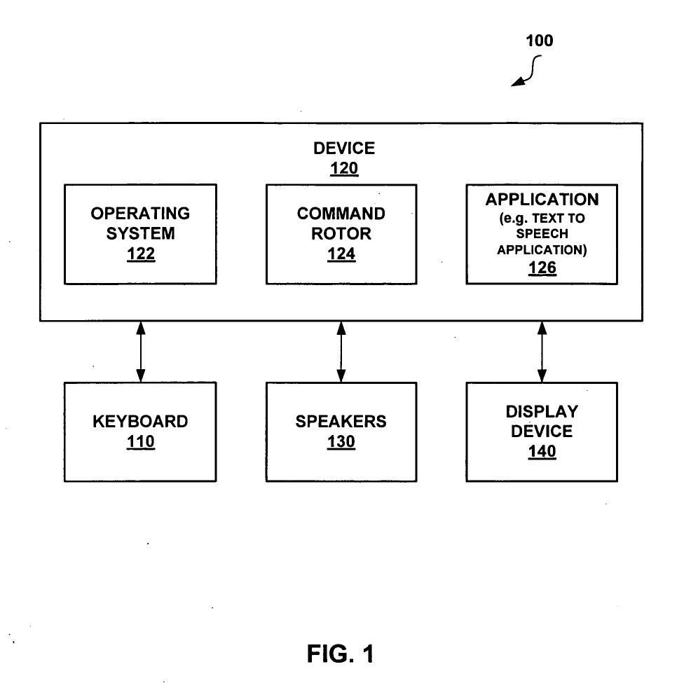

FIG. 1 is a block diagram illustrating a system 100 for adjusting parameters associated with a device. Generally, parameters are settings adjustable in a dimension (such as volume, brightness, etc) and have a default value that can be manipulated by user interaction. The device can be a personal computer, a laptop computer, a portable electronic device, a telephone, a PDA, a portable music player, a computing device, an embedded electronic device or appliance, and the like that includes input/output and can have parameters related to output. System 100 includes a user input device and various input/output devices (in this example a keyboard 110, a device 120, speakers 130, and a display device 140). Device 120 further includes an operating system 122, a command rotor 124, and an application 126 (e.g., a text-to-speech application).

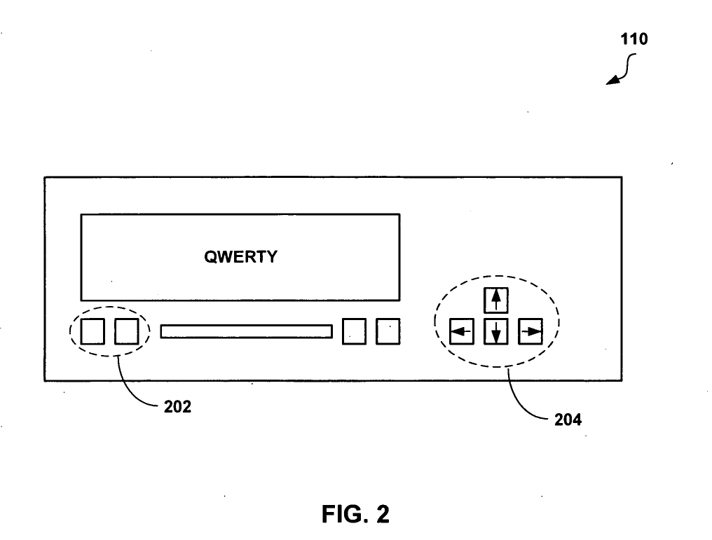

Keyboard 110 provides user input to device 120. In one implementation, keyboard 110 can be a physical QWERTY device, a phone dial pad, a keypad, a mouse, a joystick, a microphone or another input device. In another implementation, keyboard 110 can be a virtual or soft key keyboard displayed on, for example, display device 140 or other touch screen device. In one implementation, keyboard 110 allows a user to input adjustments to settings associated with, for example, application 126, input/output devices or other components of system 100. Further details of keyboard 110 are described below with respect to FIG. 2.

Device 120 receives input from keyboard 110 (or display device 140) as discussed and provides outputs to various output devices (e.g., speakers 130 and display device 140). Input can be information related to physical or virtual key manipulations, voice commands, and the like. Device 120 can control associated hardware such as speakers 130. For example, an audio card can provide amplified audio output to speakers 130 at different levels of amplitude.

Operating system 122 can be, for example, MAC OS X by Apple Computer, Inc. of Cupertino, Calif., a Microsoft Windows operating system, a mobile operating system, control software, and the like. In some implementations, operating system 122 uses drivers to control system settings of device 120. To do so, operating system 122 interfaces between low-level information received from system hardware and high-level commands received from, for example, command rotor 124. For example, operating system 122 can manage drivers for adjusting the settings of various input/output devices including for example, speakers 130 (e.g., volume), display device 140 (e.g., brightness and contrast), and other system hardware. In some implementations, operating system 122 provides a graphical user interface (not shown) that uses pop-up windows, drop boxes, dialogues, and other graphics mechanisms for adjusting settings.

More generally, a kernel layer (not shown) in operating system 122 can be responsible for general management of system resources and processing time. A core layer can provide a set of interfaces, programs and services for use by the kernel layer. A user interface layer can include APIs (Application Program Interfaces), services and programs to support user applications.

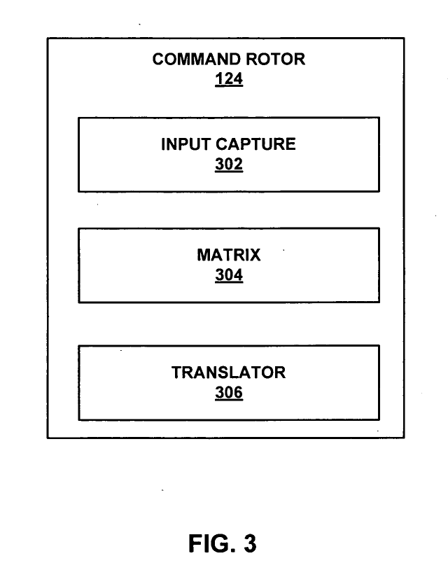

Command rotor 124 can be, for example, an application program (e.g., plug-in application program), a daemon, or a process. In some implementations, command rotor 124 is integrated into operating system 122, or application 126. In one implementation, command rotor 124 is enabled upon triggering (e.g., depression) of an activation key. Command rotor 124 navigates through parameters and parameter levels in response to triggering of a set of keys on an input device (e.g., keyboard 110), voice commands, and the like. Command rotor 124 can adjust the levels of parameters by, for example, sending commands to operating system 122 or application 126. For example, command rotor 124 can send a command to lower/raise a level of power output to speakers 130. In another example, command rotor 124 can lower/raise a level of verbosity for a text-to speech application. Further implementations of command rotor 124 are discussed below with respect to FIG. 3.

Application 126 can be a text-to-speech application executing on device 120. Application 126 can include associated parameters that are able to be adjusted by user interaction. Example applications can include a voice recognition application, a word processing application, an Internet browser, a spreadsheet application, video games, email applications, and the like. For example, application 126 can be VoiceOver by Apple Computer, Inc. or another accessibility application. In one implementation, application 126 provides audio that is output to an output device (e.g., speakers 130) and that can be adjusted in parameter levels set by user actions. In this example, a text-to-speech application (e.g., application 126) can access various audio segments based on commands sent from command rotor 124 which are output to speakers 130. Generally, a text-to-speech application converts text descriptions of applications, text, or user interactions in to speech. Additional accessibility tools can include audible output magnification, Braille output, and the like. Example settings for adjustment in application 126 include voice characteristics (e.g., rate, pitch, volume) and speech frequency characteristics (e.g., punctuation verbosity and typing verbosity).

In one implementation, speakers 130 and display device 140 can have adjustable settings separate from settings in applications such as application 126. For example, an overall speaker volume level can be adjusted whereas application 126 can adjust a speaker volume level of only its associated audio segments. Operating system 122 can set the volume level through a driver of an audio card. In another example, brightness and contrast of display device 140 can be adjusted with a driver for display device 140.

FIG. 2 is a schematic diagram illustrating one implementation of a keyboard 110 for use by system 100. Keyboard 110 includes activation keys 202 and command rotor keys 204 among other keys.

Activation keys 202 can include one key or a combination of keys such as a CNTRL key, an ALT key, an OPTION key, or another function enabling or modifying key. Activation keys 202 can disable default or predetermined functions associated with command rotor keys 204 that are active during normal operating conditions of keyboard 110. Activation keys 202 can also (e.g., at the same time) enable functions associated with command rotor 124 (FIG. 1). Enabled functions can remain active, in one implementation, while activation keys 202 are depressed, rotated, toggled, etc. and, in another implementation, until deactivation keys (e.g., similar to activation keys 202) are depressed, rotated, toggled, etc.

Command rotor keys 204 includes sets of keys such as up, down, left, and right arrows, at least one set of keys for selection of a parameter and one set of keys for adjustment of the selection. In the implementation shown, command rotor keys 204 form an inverted ‘T’ configuration, with left, right, up and down arrow keys. In other implementations, command rotor keys 204 are proximately located such that they can be accessed by one hand without significant movement (e.g., to be easily accessed by users with limited motor skills or vision). Command rotor keys 204 can allow a user to easily make changes to settings of a parameter associated with the operation or use of a device (e.g., device 120). For example, left and right arrow buttons can scroll through various parameters when depressed. Also, up and down buttons can adjust a dimension (e.g., levels) of a parameter. Activation of command rotor keys 204 can be by, for example, depressing means or by alternative means (e.g., voice activation).

FIG. 3 is a block diagram illustrating one implementation of command rotor 124. Command rotor 124 includes an input capture routine 302, a matrix 304 of parameters and levels, and a translator 306.

Input capture routine 302 can be a daemon, an accessibility API, or other process and can, in some implementations, execute on a dedicated thread. In one implementation, input capture routine 302 monitors user input to detect when a user enables an activation key (e.g., toggles, selects, or speaks an activation command). In response, input capture routine 302 enables use of matrix 304. In addition, input capture routine 302 can receive input information corresponding to activation of command rotor keys to navigate matrix 304. Input capture routine 302 can track applications being executed by an operating system and analyze associated input and output to determine if it should be forwarded to matrix 304.

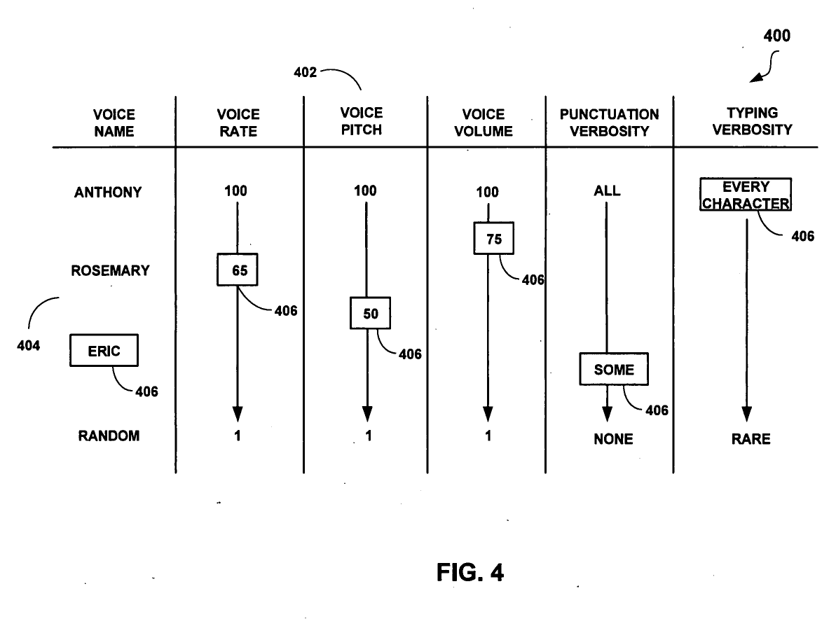

Matrix 304 can be a database or other listing of parameters and associated levels. FIG. 4 is a table 400 illustrating one implementation of matrix 304. Columns 402 include parameters for adjustment and rows 404 include levels corresponding to each parameter. Windows 406 show a current level of the respective parameters. In one implementation described below, values of levels in windows 406 are stored upon exiting a particular parameter. Windows 406 can move up or down columns 402 while a user is adjusting a desired parameter and be highlighted when active (e.g., when under the control of command keys). In one implementation, a value in window 406 is displayed while being adjusted.

Referring again to FIG. 3, translator 306 receives user inputs (e.g., in the form of activated keys) and outputs commands related to parameter adjustments. In some implementations, a window value is translated to a command for an operating system in its interaction with appropriate drivers. In other implementations, a window value is translated to text describing a new level (e.g., ‘level 7’), or a relative movement in levels (e.g., ‘up’ and ‘down’) to be displayed or otherwise output to a user as a feedback.

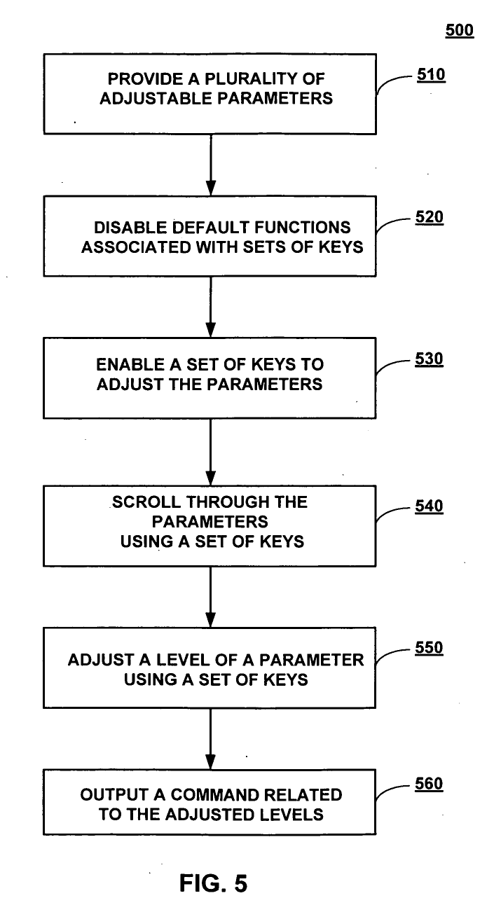

FIG. 5 is a flow diagram illustrating a method 500 for adjusting parameter levels. A plurality of adjustable parameters is provided 510 (e.g., a matrix 304 of parameters associated with command rotor 124). At initialization or boot up of applications or system hardware, adjustable settings are associated with the parameter or loaded (e.g., default values are populated in matrix 304). Settings can be predetermined or customizable by a user. In one implementation, settings are related to each other (e.g., include voice pitch and voice volume from a common text-to-speech application).

Default functions associated with sets of keys are disabled 520 (e.g., by activation keys 202, deactivation keys, or voice commands as detected by input capture routine 302). The default functions are suspended while activation keys remain enabled or until deactivation keys are enabled. A set of keys to adjust the parameters is enabled 530 (e.g., physical or virtual command rotor keys 204). More specifically, the command rotor keys can be used to navigate matrix 304 (e.g., by key manipulation or voice commands).

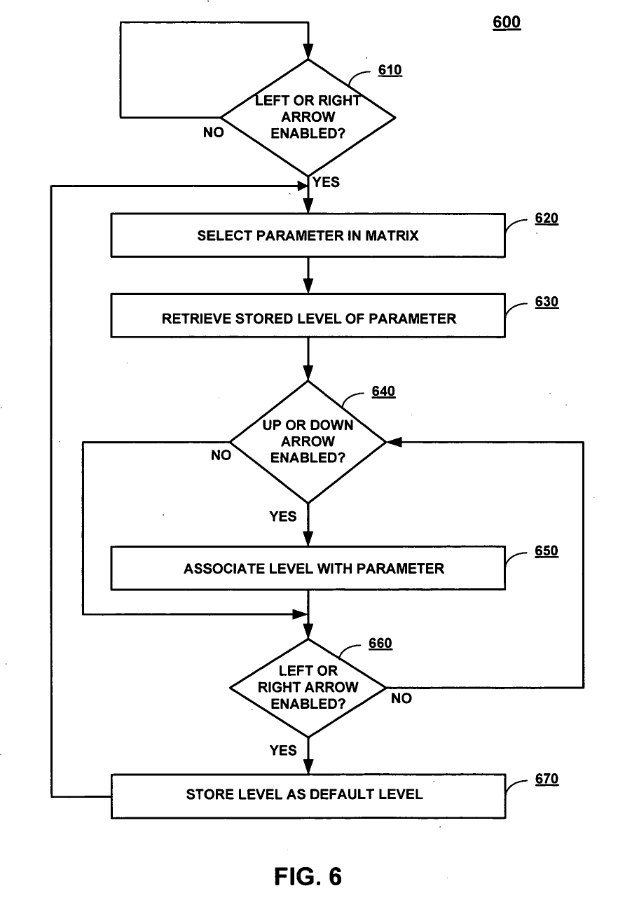

The parameters are scrolled 540 using a first set of keys and a level of a parameter is adjusted 550 using, for example, a different set of keys, as described in more detail below with respect to FIG. 6. A command related to the adjusted level is output 560 (e.g., by translator 306). For example, text related to a selected voice rate of ‘85’ can be output to application 126 (e.g., a text-to-speech application) which outputs a related audio segment (e.g., through speakers 130). In another example, a general speaker setting of ‘65’ can result in an output to an operating system (e.g., operating system 122) which changes a volume setting of an associated device and can optionally display the new setting (e.g., through display device 140).

FIG. 6 is a flow diagram illustrating a method 600 for scrolling through and adjusting parameters. A first set of keys are activated, for example, a left or right arrow is enabled (e.g., depressed) 610 and detected by an input capture routine. In response, a parameter in the matrix is selected 620 (e.g., a next or last parameters associated with columns 402 of matrix 304 is selected). In one implementation, advancing is circular in that after a last parameter is reached, a first parameter is next.

A stored level of a parameter is retrieved 630 upon selection of the parameter, and optionally displayed, from which adjustments are made. A second set of keys, for example, an up or down arrow, is enabled 640. In response, a level is associated with the parameter 650 from a current level and optionally displayed (e.g., window 406 in row 404 of levels). The first set of keys may be manipulated, for example, the left or right arrow may be depressed 660, to select another parameter for adjustment. In response, a current level of the selected parameter is stored 670. As a result, repeated scrolling toggles through current levels of the parameter.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a display, e.g., a CRT (cathode ray tube) or LCD (liquid crystal display) monitor, for displaying information to the user and an input device, e.g., a keyboard, a mouse, a trackball, and the like by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in, e.g., a computing system, a handheld device, a telephone, a consumer appliance, or any other processor-based device. A computing system implementation can include a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example the first and second sets of keys can be one or two keys, or the same keys. In addition to keys, users can enable a mouse, a thumbwheel, or other input device to make adjustments. Accordingly, other implementations are within the scope of the following claims.

What is claimed is:

1. A method, including:
providing a plurality of parameters, each parameter being adjustable over a dimension;
enabling a set of keys to adjust the plurality of parameters;
selecting from amongst the plurality of parameters a parameter for adjustment using a first set of one or more keys from the set of keys; and
adjusting a dimension of a selected parameter using a second set of one or more keys from the set of keys.

2. The method of claim 1, wherein the plurality of parameters include parameters associated with a text-to-speech application.

3. The method of claim 2, wherein the plurality of parameters associated with the text-to-speech application include one or more of voice rate, voice pitch, or voice volume.

4. The method of claim 1, wherein the plurality of parameters include parameters associated with system hardware.

5. The method of claim 1, wherein the dimension includes a range of levels.

6. The method of claim 1, wherein each key in the set of keys are proximately located relative to other keys.

7. The method of claim 1, wherein each key in the set of keys include virtual keys.

8. The method of claim 1, further including:
disabling default functions associated with the set of keys.

9. The method of claim 1, wherein enabling includes:
responsive to depressing one or more activation keys, enabling the set of keys to adjust the plurality of parameters.

10. The method of claim 1, wherein selecting includes:
scrolling through the plurality of parameters to select the parameter for adjustment.

11. The method of claim 1, further including:
storing a dimension level associated with each of the plurality of parameters, wherein
selecting includes displaying the stored levels while scrolling through the plurality of parameters.

12. The method of claim 1, further including:
outputting an audio segment in accordance with the adjusted level.

13. The method of claim 1, wherein adjusting includes:
outputting to an operating system a command in accordance with the adjusted dimension level.

14. A computer program product including instructions tangibly stored on a computer-readable medium, the product including:
an input capture routine to receive input from a command rotor associated with a plurality of parameters, each parameter being adjustable over a dimension, the input capture routine detecting enablement of the command rotor; and
a matrix, in communication with the input capture routine and responsive to a first set of one or more keys from a set of keys associated with the command rotor, to select a parameter for adjustment and, responsive to a second set of one or more keys from the set of keys associated with the command rotor, to adjust a dimension of a selected parameter.

15. A system, including:
an input capture routine to receive input from a command rotor associated with a plurality of parameters, each parameter being adjustable over a dimension, the input capture routine detecting enablement of the command rotor; and
a matrix, in communication with the input capture routine and responsive to a first set of one or more keys from a set of keys associated with the command rotor, to select a parameter for adjustment and, responsive to a second set of one or more keys from the set of keys associated with the command rotor, to adjust a dimension of a selected parameter.

16. The system of claim 15, wherein the plurality of parameters include parameters associated with a text-to-speech application.

17. The system of claim 16, wherein the plurality of parameters associated with the text-to-speech application include one or more of voice rate, voice pitch, or voice volume.

18. The system of claim 15, wherein the plurality of parameters include parameters associated with system hardware.

19. The system of claim 15, wherein the dimension includes a range of levels.

20. The system of claim 15, wherein each key in the set of keys are proximately located relative to other keys.

21. The system of claim 15, wherein each key in the set of keys include virtual keys.

22. The system of claim 15, wherein the input capture routine disables default functions associated with the set of keys.

23. The system of claim 15, wherein the input capture routine, responsive to depressing one or more activation keys, enables the set of keys to adjust the plurality of parameters.

24. The system of claim 15, wherein the matrix scrolls through the plurality of parameters to select the parameter for adjustment.

25. The system of claim 15, wherein the matrix stores a dimension level associated with each of the plurality of parameters and displays the stored levels while scrolling through the plurality of parameters.

26. The system of claim 15, further including:
an audio output to output an audio segment in accordance with the adjusted level.

27. The system of claim 15, further including:
a translator, coupled to the matrix, to output to an operating system a command in accordance with the adjusted dimension level.
